(19) United States
(12) Patent Application Publication
(10) Pub. No.: US 2008/0074792 A1
(43) Pub. Date: Mar. 27, 2008

(54) CONTROL SCHEME FOR A MEMORY DEVICE

(75) Inventors: Robert N. Stark, Saratoga, CA (US); Donald Edward Adams, Pleasanton, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 11/625,235

(22) Filed: Jan. 19, 2007

Related U.S. Application Data
(60) Provisional application No. 60/846,605, filed on Sep. 21, 2006.

(51) Int. Cl. G11B 5/48

(52) U.S. Cl. 360/240

(57) ABSTRACT

A system for storing information comprises a media die including a frame and a media platform movably coupled with the frame, a media associated with the media platform, one or more capacitive sensors including an electrode fixedly connected with the media platform, and a tip platform including a tip, the tip platform positioned relative to the media platform such that the tip is arrangeable in communicative proximity to the media. The system further comprises circuitry to provide motion signals to urge the media platform relative to the tip platform, the circuitry including a coarse tracking loop, wherein the coarse tracking loop includes a trajectory generator and a primary control loop to adjust a trajectory generated by the trajectory generator based on a measurement from the one or more capacitive sensors.

### CROSS-REFERENCE TO RELATED PATENT APPLICATIONS

This application incorporates by reference all of the following co-pending application:

U.S. patent application Ser. No. 11/553,421, entitled “Bonded Chip Assembly with a Micro-Mover for Microelectromechanical Systems,” Attorney Docket No. NANO-01041US1, filed Oct. 26, 2006.

U.S. patent application Ser. No. 11/553,435, entitled “Memory Stage for a Probe Storage Device,” Attorney Docket No. NANO-01043US1, filed Oct. 26, 2006.

U.S. patent application Ser. No. 11/553,408, entitled “Cantilever with Control of Vertical and Lateral Position of Contact Probe Tip,” Attorney Docket No. NANO-01044US1, filed Oct. 26, 2006.

U.S. patent application Ser. No. 11/553,449 entitled “Cantilever with control of Vertical and Lateral Position of Contact Probe Tip,” Attorney Docket No. NANO-01044US2, filed Oct. 26, 2006.

U.S. patent application Ser. No. 60/846,605, entitled “Architecture for a Memory Device,” Attorney Docket No. NAN-01045US0, filed Sep. 21, 2006.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to high density data storage using molecular memory integrated circuits.

### BACKGROUND

Software developers continue to develop steadily more data intensive products, such as ever-more sophisticated, and graphic intensive applications and operating systems (OS). Each generation of application or OS always seems to earn the derisive label in computing circles of being “a memory hog.” Higher capacity data storage, both volatile and non-volatile, has been in persistent demand for storing code for such applications. Add to this need for capacity, the confluence of personal computing and consumer electronics in the form of personal MP3 players, such as the iPod, personal digital assistants (PDAs), sophisticated mobile phones, and laptop computers, which has placed a premium on compactness and reliability.

Nearly every personal computer and server in use today contains one or more hard disk drives for permanently storing frequently accessed data. Every mainframe and supercomputer is connected to hundreds of hard disk drives. Consumer electronic goods ranging from camcorders to TiVo® use hard disk drives. While hard disk drives store large amounts of data, they consume a great deal of power, require long access times, and require “spin-up” time on power-up. FLASH memory is a more readily accessible form of data storage and a solid-state solution to the lag time and high power consumption problems inherent in hard disk drives. Like hard disk drives, FLASH memory can store data in a non-volatile fashion, but the cost per megabyte is dramatically higher than the cost per megabyte of an equivalent amount of space on a hard disk drive, and is therefore sparingly used.

Phase change media are used in the data storage industry as an alternative to traditional recording devices such as magnetic recorders (tape recorders and hard disk drives) and solid state transistors (EEPROM and FLASH). CD-RW data storage discs and recording drives use phase change technology to enable write-erase capability on a compact disc-style media format. CD-RWs take advantage of changes in optical properties (e.g., reflectivity) when phase change material is heated to induce a phase change from a crystalline state to an amorphous state. A “bit” is read when the phase change material subsequently passes under a laser, the reflection of which is dependent on the optical properties of the material. Unfortunately, current technology is limited by the wavelength of the laser, and does not enable the very high densities required for use in today's high capacity portable electronics and tomorrow's next generation technology such as systems-on-a-chip and micro-electric mechanical systems (MEMS). Consequently, there is a need for solutions which permit higher density data storage.

### BRIEF DESCRIPTION OF THE DRAWINGS

Further details of the present invention are explained with the help of the attached drawings in which:

FIG. 1 is a schematic reprepresentation of an embodiment of a system for communicatively connecting a plurality of tips with control electronics in accordance with the present invention; FIG. 1B is a portion of the schematic of FIG. 1A illustrating a tip in electrical communication with the control electronics.

FIG. 2 is a schematic representation of an embodiment of a memory device for use in storing information in accordance with the present invention employing the schematic representation of FIG. 1A.

FIG. 3 is a plan view of an embodiment of a media platform having capacitive sensors.

FIG. 4 is an exploded view of an embodiment of an assembly for use in probe storage devices in accordance with the present invention.

FIG. 5 is a schematic representation of an embodiment of a system for storing information comprising a plurality of the memory devices of FIG. 2.

FIG. 6 is a control schematic of an embodiment of a media platform for use in systems for storing information in accordance with the present invention.

FIG. 7 is a portion of the control schematic of FIG. 6 illustrating an adjustment algorithm for adjusting fine position of tips relative to platform movement along an x axis.

FIG. 8 is a control schematic of a portion of an alternative embodiment of a media platform for use in systems for storing information in accordance with the present invention.

### DETAILED DESCRIPTION

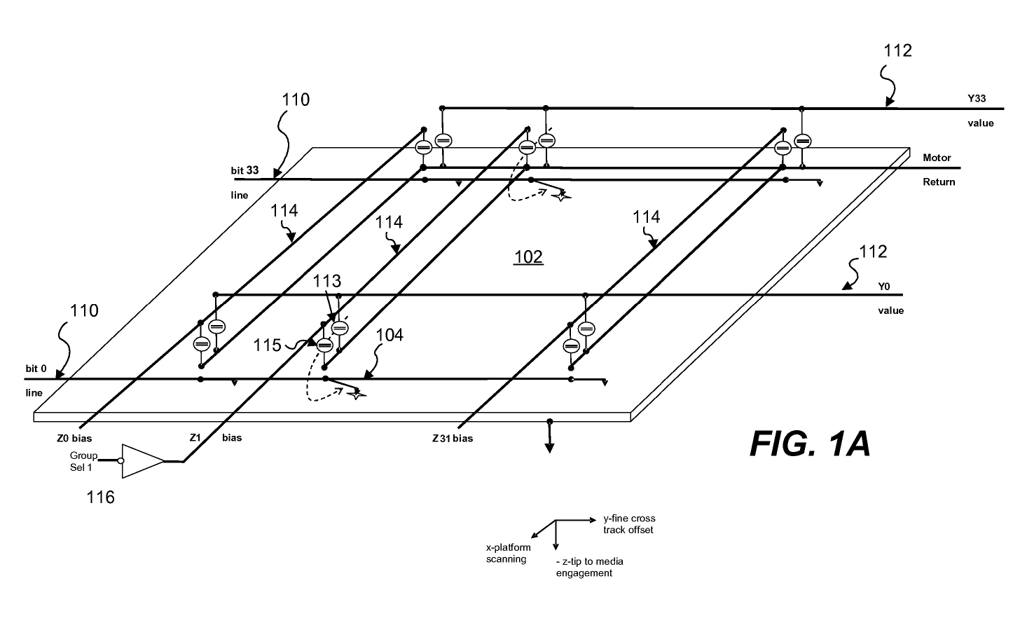

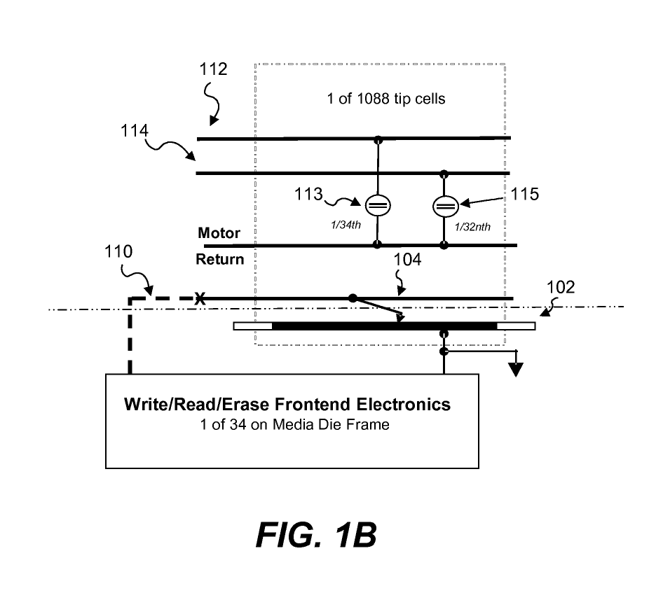

FIG. 1A is a schematic representation of an embodiment of a portion of a memory device in accordance with the present invention comprising a plurality of tips 104 arranged in groups and actuatable to contact a media 102 of a media die for forming or reading indicia in the media 102 and/or on the surface of the media 102. The tips 104 can be arranged in groups to reduce a number of “active” tips 104 from which signals are sent and received, thereby minifying a number of interconnects between a tip die and control circuitry of the memory device. Common interconnects, which can include for example bit lines 110 and planar offset interconnects 112, etc., can be electrically connectable with any and/or all of the groups. To reduce a total number of interconnects required, a selected group 116 is electrically connected with common interconnects, while unselected groups are disconnected from common interconnects. The selected group 116 can be electrically connected by way of z-actuators 115 that urge tips 104 of the group so that the tips 104 contact the media 102. Group actuation interconnects 114 associated with each group can carry signals to the z-actuators 115 to actuate tips 104 of the group.

The number of tips 104 deployable on a tip platform associated with a tip die, and the number of groups 116 into which the number of tips 104 are arranged, can determine a number of interconnects between the tip die and the media 102. For example, if 1,088 deployable tips 104 extend from the platform, and the 1,088 tips 104 are arranged in thirty-two groups 116 having substantially the same number of respective deployable tips 104, it is desirable that thirty-four bit lines 110 be employed to receive and provide signals to the tips 104. Use of common interconnects enables management of a large potential number of signals and thereby increases flexibility in design. For example, as shown in FIGS. 1A and 1B, a tip 104 from each group can employ a common planar offset interconnect 112 to allow fine position correction for the tip 104 of the selected group 116 by planar actuation of a cantilever associated with the tip 104. In some embodiments, electrostatic actuators 113 can be incorporated to enable fine positioning of the tips 104 across a desired number of tracks, for example +/−3 tracks. U.S. patent application Ser. No. 11/553,408, entitled “Cantilever with Control of Vertical and Lateral Position of a Contact Probe Tip,” (Attorney Docket: NANO-01044US1) and U.S. patent application Ser. No. 11/553,449, entitled “Cantilever with Control of Vertical and Lateral Position of a Contact Probe Tip,” (Attorney Docket: NANO-01044US2) incorporated herein by reference, discloses an electrostatic actuator for fine positioning of a tip across multiple tracks.

Use of fine position correction mechanisms (such as electrostatic actuators) for multiple tips can enable a method of self-servo writing on continuous media. For example, in one embodiment of a method of self-servo writing, adjacent tracks can be written to a media having an approximately uniform pitch separating the tracks. To achieve the approximately uniform pitch the tips can be separated into two groups during self servo writing. A first track can be written to the media using both groups of tips, the media and the tips being moved relative to one another as guided by a coarse position sensor. Half of the written lines can then be tracked by one of the two groups of tips using the coarse position sensor and the fine positioning error from the group of tips. The other of the two groups of tips can be offset using the fine position correction mechanisms, for example one track pitch in distance. A new track can be written by the other of the two groups of tips while tracking the originally written track with the one of the two groups of tips. The tracking and writing groups of tips can then be alternated to complete the writing of the adjacent track. The process can be repeated as desired to self-servo write the continuous media. In still other embodiments, some other combination of track following and track writing can be employed using coarse position sensors and fine position correction mechanisms to self-servo write a continuous media. One of ordinary skill in the art, in light of the present teachings, will appreciate that myriad different variations that can be applied to self-servo write a media using a combination of the coarse positioning sensors and fine positioning mechanisms. The present invention is not intended to be limited to self-servo writing by dividing tips into two groups, but rather the present invention is meant to encompass all such schemes that can take advantage of coarse position sensors and fine position mechanisms for enabling fine position offsets between tips.

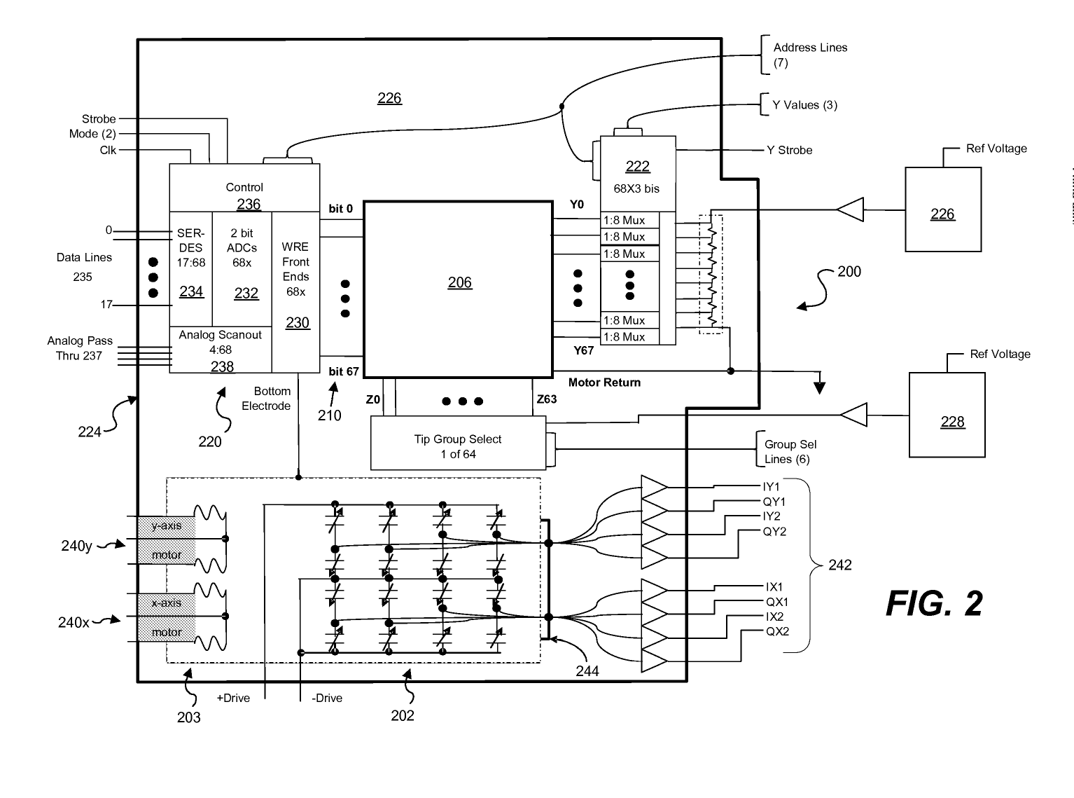

Referring to FIG. 2, an embodiment of a memory device 200 in accordance with the present invention is shown. In the embodiment, a tip die 206 supports 4,352 deployable tips arranged in sixty-four groups. The tip die 206 employs sixty-eight active bit lines (four bit lines being used for error correcting code (ECC)) to electrically communicate with all active group of sixty-eight tips. The memory device controller 220 and associated circuitry can be built onto the media frame 226 (i.e., the stationary portion) of the media die 224. Alternatively, the memory device controller 220 and associated circuitry can be built external to the media die 224, for example on a circuit board or on the tip die 206.

A planar offset register bank 222 can selectably provide planar offset information through the common planar offset interconnect 212 based on a selected group. The planar offset register bank 222 can store planar offset information for each tip (e.g., 4,352 values for the tip die 206 described above) while a number of common planar offset interconnects 212 required are as few as the number of tips of the selected group. The planar offset information can be provided through a slave digital-to-analog converter (DAC)(not shown). The slave DAC includes 68×3 bits of local memory, and the planar offset information is multiplexed out from the slave DAC to the tips of the selected group. A master DAC 226 provides an input for the slave DAC.

As schematically illustrated, a tip die 206 supporting 4,352 tips can electrically communicate with the memory device controller 220 using 201 interconnects (including a motor return interconnect). The common interconnects are reducible to 133 where planar offsets are not employed, or where planar offsets are multiplexed using a bit line, for example. The tip die 206 can be fixedly associated with the media frame 226 to avoid a need for flexible interconnects communicating the tip die 206 with the memory device controller 220. However, where a movable tip platform is employed, minifying interconnects can be important for reducing the complexity of integrating the media device.

As shown, group select provides an actuation signal that allows tips within the group to actuate toward the media 202, contacting the media 202 to form circuits with the common interconnects. In an embodiment, the actuation mechanism employed can be an electrostatic actuator so that the actuation signal removes an electrostatic force between electrodes, for example as described in U.S. patent application Ser. No. 11/553,408, entitled “Cantilever with Control of Vertical and Lateral Position of a Contact Probe Tip,” (Attorney Docket: NANO-01044US1) and U.S. patent application Ser. No. 11/553,449 entitled “Cantilever with Control of Vertical and Lateral Position of a Contact Probe Tip,” (Attorney Docket: NANO-01044US2). In other embodiments, the electrostatic actuator can be employed to urge the tip toward the media when an actuation signal is applied. In still further embodiments, the actuation mechanism can be some other mechanism, such as a thermal bimorph, or an electromagnetic actuator. Group select circuitry can be formed on the media die 224 to reduce a number of pins for providing signals to the tip die 206. An actuation force DAC 228 arranged outside of the media device 200 can allow the actuation force to be generally adjusted, providing external actuation control by way of a one pin connection, although in other embodiments, pins can be provided for actuation control external of the media device 200 for each of the active tips.

The memory device controller 220 comprises write/read front-end electronics 230 electrically connectable with the tip die 206 by wav of bit lines 210. In the embodiment shown, there can be sixty-eight bit lines 210 for sixty-eight tips. The memory device controller 220 further comprises analog-to-digital converters (ADC) 232 for preliminary decision-making and a serializer/deserializer (SERDES) 234 for converting data from/to a serial data stream and a parallel data stream. Binary data is multiplexed to 17 data lines 235 by way of the SERDES. Still further, the memory device controller 220 includes a control 236 for multiplexing and an analog pass-through scan-out 238 where 4 of 68 of the bit lines 237 are passed out for the primary purpose of scanning-out fine position information embedded in data for off-set and thermal drift control of the tips. The scanned-out information can be used to control the values updated for updating the planar offset register bank 222 to keep tips centered as temperature changes and the tips are subjected to thermal drift effects. Final ECC can be employed to correct incorrect determinations of the memory device controller 220.

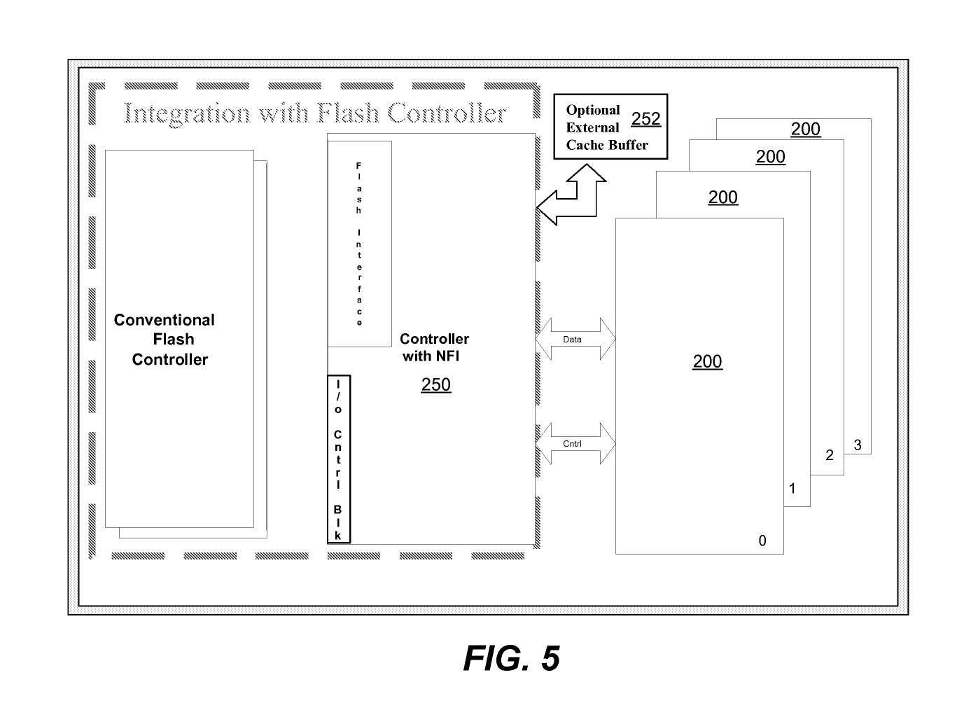

The analog pass-through scan-out 238 described above allows detection of a servo pattern embedded on the media 202 and arranged within data and read by four tips at a given time (in an embodiment). Thus, in this example the analog pass-through scan-out 238 scans out information from four tips at a time cycling through the sixty-eight tips. The position is modulated through a feedback control loop (see FIG. 5) that updates planar offset data for the corresponding tip for which scan-out data is obtained. The master offset DC 226 can be adjusted and the individual planar offset value can be adjusted for the corresponding tip. In an embodiment, the feedback control loop can be included in a controller chip (by way of a digital signal processor (DSP))

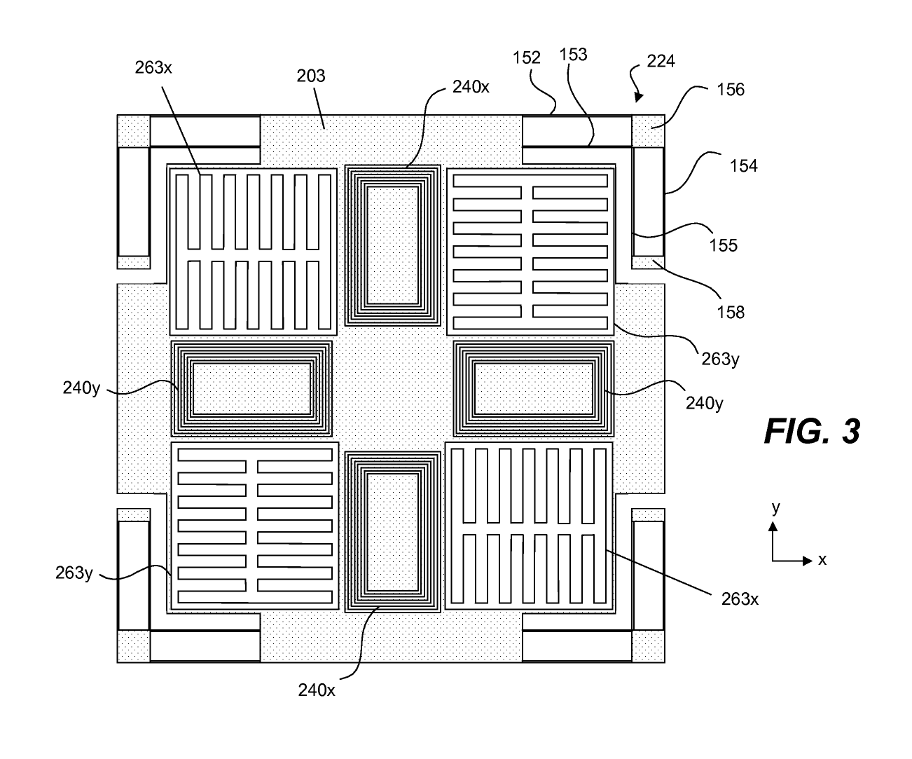

The media 202 for storing indicia is associated with a movable portion of the media die 224 referred herein as a media platform 203. The media platform 203 is electrically connected with the memory device controller 220, forming a circuit allowing indicia to be formed and/or read from the media 102. Referring to FIG. 3, the media platform 203 is movable in a Cartesian plane by way of electro-magnetic motors 240 comprising operatively connected wires (also referred to herein as coils, although the wires need not consist of closed loops) placed in a magnetic field such that motion of the media platform 203 can be achieved when current is applied to the wires. The corresponding tip platform can be fixed in position. The media platform 203 can be urged in a Cartesian plane by taking advantage of Lorentz forces generated from current flowing in the coils 240 when a magnetic field perpendicular to the Cartesian plane is applied across the coil current path. The coils 240 can be arranged at ends of two perpendicular axes and can be formed such that the media 202 is disposed between the coils 240 and the tip platform (e.g. fixedly connected with a back of the media platform 203, wherein the back is a surface of the media platform 203 opposite a surface contactable by the tip platform). In a preferred embodiment, the coils 240 can be arranged symmetrically about a center of the media platform, with one pair of coils 240x generating force for lateral (X) motion and the other pair of coils 240y generating force for transverse (Y) motion. Utilization of the surface of the media platform for data storage need not be affected by the coil layout because the coils can be positioned so that the media for storing data is disposed between the coils an- the tip platform, rather than co-planar with the coils. In other embodiments the coils can be formed co-planar with the surface of media platform. In such embodiments, a portion of the surface of the media platform will be dedicated to the coils, reducing utilization for data storage.

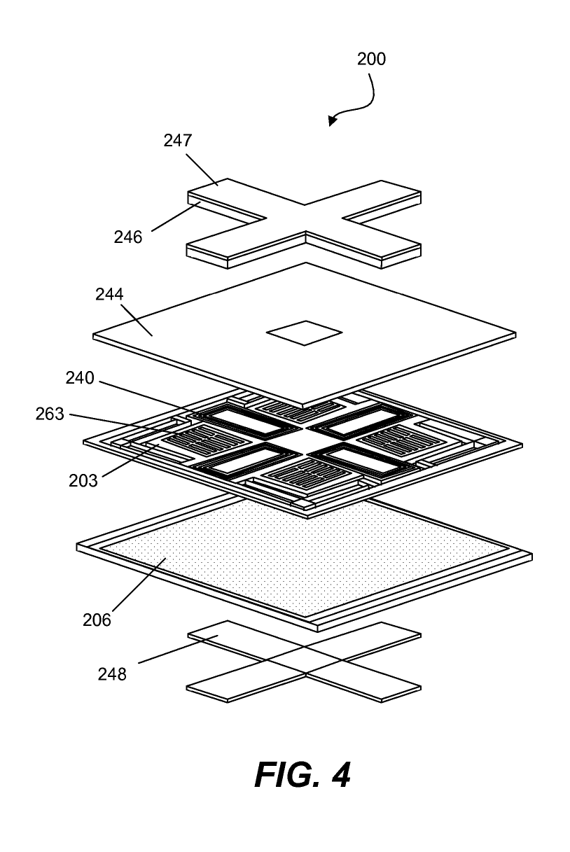

Referring to FIG. 4, a magnetic field is generated outside of the media platform 203 by a permanent magnet 246 arranged so that the permanent magnet 246 maps the two perpendicular axes, the ends of which include the coils. The permanent magnet can be fixedly connected with a rigid structure such as a steel plate 247 to form a magnet structure. The magnet structure can be associated with a cap wafer 244. A second steel plate 248 can be arranged so that the tip die 206, media platform 203, and coils 240 are disposed between the magnet structure and the second steel plate 248. The magnetic flux is contained within the gap between the magnet structure and the second steel plate. In alternative embodiments, a pair of magnets can be employed such that the platforms and coils are disposed between dual magnets, thereby increasing the flux density in the gap between the magnets. The force generated from the coil is proportional to the flux density, thus the required current and power to move the media platform can be reduced at the expense of a larger package thickness. There is a possibility that a write current applied to one or more tips could disturb the media platform due to undesirable Lorentz force. However, for probe storage devices having media devices comprising phase change material, polarity dependent material, ferroelectric material or other material requiring similar or smaller write currents to induce changes in material properties, media platform movement due to write currents is sufficiently small as to be within track following tolerance. In some embodiments, it can be desired that electrical trace lay-out be configured to generally negate the current applied to the tip, thereby minifying the influence of write current.

Coarse servo control of the media platform 203 can be achieved through the use of capacitive sensors. The media platform 203 can rely on a pair of capacitive sensors arranged at four locations using each pair of capacitive sensors for extracting a ratiometric signal independent of Z-displacement of the media platform 203. Two electrodes (not shown) are formed on one or both of the top and bottom caps 244. A third electrode 263 is integrally formed or fixedly connected with the media platform 203 to form a differential pair. Two capacitors are formed between the first electrode and third electrode 263, and between the second electrode and the third electrode 263. A ratio of capacitances can be sensitive to horizontal displacement of the media platform 203 with respect to the stationary portion 226 in the plane of the figure (X-displacement) and this ratio can be insensitive to Y and Z displacements of the media platform 203 with respect to the stationary portion. Thus, for a pair of capacitive sensors adapted to measure motion along an axis, at least two readings can be obtained from which can be extracted displacement along the axis and rotation about a center of the media platform 203. Four electrodes 263 are integrally formed or fixedly connected with the media platform 203. As shown in FIG. 3, the electrodes 263 are arranged in quarters of the media platform 203. Two electrodes 263x are designed to provide signals proportional to X displacement of the media platform 203, and two other electrodes 263y are designed to provide signals proportional to Y displacement of the media platform 203. Preferably, each electrode 263 on the media platform 203 faces a differential pair of electrodes on one or both of the caps (not shown). Processing signals from all capacitive sensors allows extracting three displacement and three rotational components of the motion of the media platform 203 with respect to one or both caps.

In alternative embodiment, the media platform can have more or fewer pairs of capacitive sensors. In particular, pairs of capacitive sensors sensitive to the same type of motion (lateral (X), transverse (Y), X-Y skew or others) can be implemented in such a way that output signal of the first sensor is close to zero level and the output signal of the second sensor is close to its full scale output when the media platform is in equilibrium position. When the media platform is in an extreme position then an output signal of the first sensor is close to its full scale output and the output signal of the second sensor is close to zero.

Electrical connections to the media platform may require use of bridges. It is desirable to minify the use of bridges; therefore, it can be advantageous to employ position sensors requiring the smallest number of electrical connections between the media platform and the stationary portion. Capacitive sensing allows electrodes located on the media platform to be connected with the substrate, which can act is a common electrode. The substrate potential can be set to ground or to the high potential. Connecting capacitor plates to the substrate creates parasitic capacitors between the substrate and the stationary portions. In order to reduce the parasitic capacitance the media platform can be micro-machined between the fingers of the electrodes. Shallow cavities in the areas between the fingers can reduce parasitic capacitance. Wires bridge across the media platform to the media frame allowing signals to be electrically communicated out side of the memory device. The capacitive sensors allow control of media platform skew, and are driven differentially. A stator portion of the capacitive sensors is associated with a cap wafer. Sense amplified signals are provided from the stators to an interface controller (not shown).

In alternative embodiments, Hall-effect sensors sensitive to magnetic field can be used to determine the position of the media platform. Hall-effect sensors measure position based on changes of the mobility of carriers in the presence of magnetic field. Hall-effect sensors can be employed in the media platform, for example, in the form of magneto-resistors or magneto-transistors. Hall-effect sensors can be arranged in areas of the media platform where a component of the magnetic field has its largest gradient. Areas with large gradients of magnetic field exist in the middle of the coils where the magnetic field changes polarity. Displacement of the media platform causes changes in the magnetic field created by stationary magnets and can be detected by the Hall-effect sensors.

In still further embodiments, thermal position sensors can be used to determine the position of the media platform. Myriad different types of thermal sensors can be employed. For example, a thermal position sensor containing a heater and a differential pair of temperature sensors can be employed. In one embodiment, a stationary heater (e.g. a resistive heater) can be formed on one of the cap wafers, and two temperature sensors can be connected with the media platform and located symmetrically with respect to the heater so that in a neutral position a differential signal from the pair of temperature sensors is small. When the media platform is urged away from a neutral position the distance between the stationary heater and one of the temperature sensors increases. Correspondingly, the distance between the heater and the other of the temperature sensors decreases. The temperature difference resulting from this movement causes an electrical signal proportional to the displacement of the media platform.

Similarly to capacitive position sensors at least four magnetic or temperature sensors can be employed in order to measure displacement of the media platform within the Cartesian plane and the angle of rotation of the media plate within the Cartesian plane. At least two additional sensors can be employed in order to measure rotation of the media platform in X-Z and Y-Z planes.

A number of pins communicating signals from the memory device to an interface controller can be reduced to approximately sixty pins. The number of pins required to vary substantially depending on the amount and type of information processed by an interface controller, and an amount and type of information processed by the memory device controller. Referring to FIG. 5, one or more memory devices 200 can be multiplexed to an interface controller 250. As shown, four memory devices 200 are multiplexed back to the interface controller 250. In an embodiment, the interface controller 250 can perform such functions as higher level tip selection and multiplexing, circuit control, servo component control, servo modulation, and DSP for x-axis scan control, y-axis seek, y-axis position, etc. The interface controller 250 can include a data path and buffer controllers, and therefore can manage data to and from the memory devices, as well as electro-magnetic position information using local buffers (external 252 or integrated). The ECC will operate on the data as necessary, and pass data to the interface controller and out according to its specifications.

The capacitive sensors described above can allow stabilization of the media platform. A system employing a mass, such as a media platform, supported or suspended by multiple springs may require an undesirably large bandwidth for communicating data to maintain stability of the mass while the mass is accessed. Use of capacitive sensors fixedly associated with the media platform can close loops that are always closed in the x and y dimensions of a Cartesian plane. If a controller desires to position the media platform at an extreme of the media platform's range of movement a servo controller can position the media platform as desired. To achieve such movement, it may be desirable to control a trajectory of the media platform, and by controlling the trajectory, vibration of the media platform can be minified.

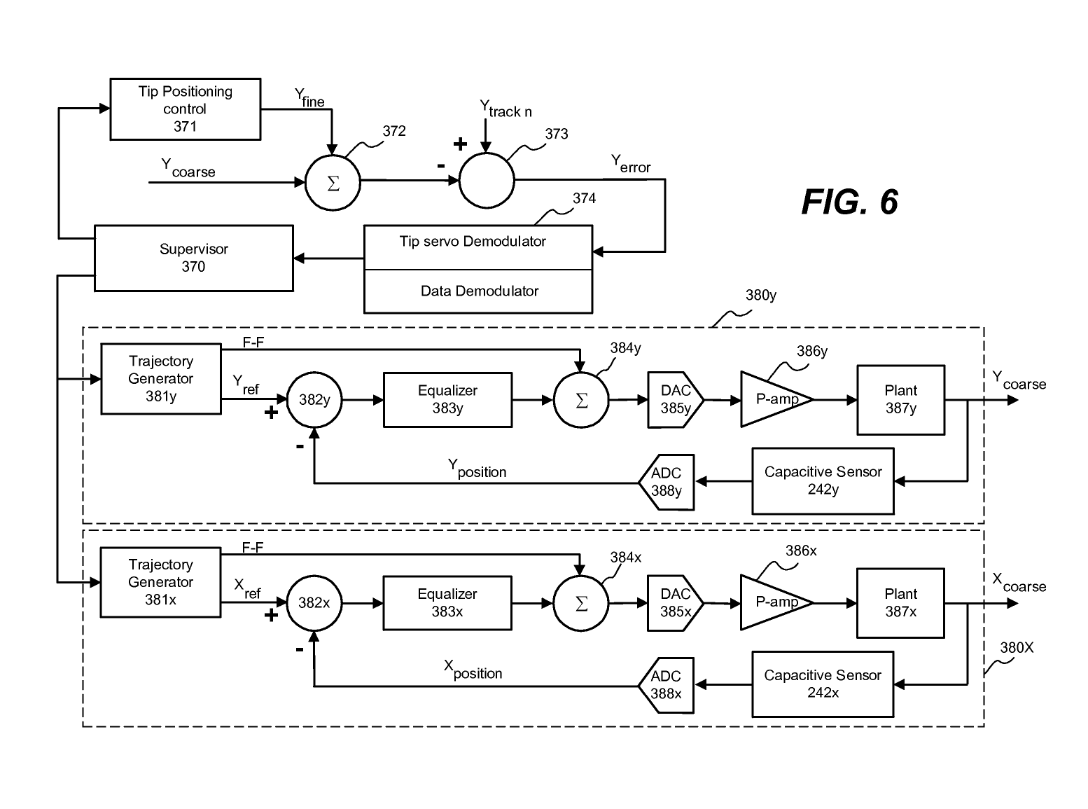

Referring to FIG. 6, embodiments of methods and systems in accordance with th present invention can be applied to control a trajectory of a media platform to reduce vibration of the media platform during positioning. Trajectory control can be approached by way of the capacitive sensors, which are known in the art to be capable of resolutions better than one nanometer, which in an embodiment can be a target resolution for achieving trajectory control. Sufficient resolution can be obtained in capacitive sensors 242x, 242y by way of multiple cycles of capacitance. With small dimensions, the capacitances can be sufficiently large to provide acceptable signal-to-noise resolution. For example, a cycle can be 10 microns in size, and can employ a 14 bit analog-to-digital converter (ADC) 388 to obtain nanometer resolution. As the media platform is moved within its range of motion, a velocity profile can be generated. As the media platform is moved, tips from a selected group approximately follow the center of tracks formed on the media. Capacitive sensors 242x, 242y can enable movement with acceptable precision (i.e. with good repeatability) as a consequence of the resolution of the capacitive sensors; however, the capacitive sensors do not necessarily communicate complete position information for the tips. Servo information read by the tips can be used in combination with the capacitive sensors 242x, 242y to align the platform for acceptably accurate and repeatable positioning.

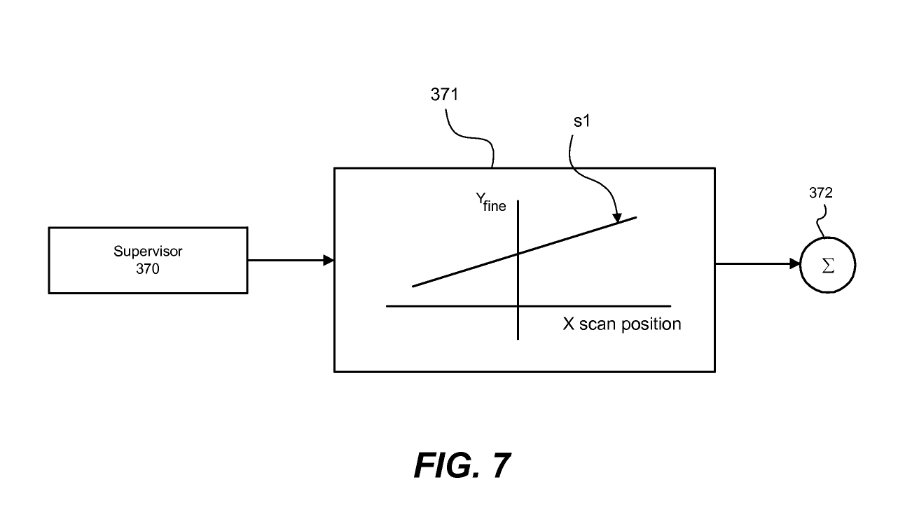

To accomplish movement approximately aligned with the track centers, the tips can be adjustable by application of a current or voltage to an electrostatic actuator, a thermal actuator or some other mechanism as described above. In an embodiment, the tips can be adjustable for example within a +/−3 track range. the alignment of the tips can be achieved by assigning offsets within the range of movement to the cantilevers, the offset adjusting the current or voltage applied to the actuator. Tip offsets can be fixed during media access, or tip offsets can be adjustable as the media platform moves relative to the tip. Referring to FIG. 7, the adjustment algorithm s1 is shown as a simple slope (i.e. a linear equation) that adjusts a Y_{fine} position of the tip to be summed 372 with the coarse position of the media platform in response to a input from the supervisor 370; however, the algorithm can alternatively be more complicated, for example a quadratic equation. In still other embodiments, the tip offset can be a simple DC offset. In such an embodiment employing sixty-eight tips as shown in FIG. 2, the planar offset register bank 222 can include sixty-eight three bit values. Tip offsets can be employed to compensate for variations in manufacturing, media platform skew, and misalignment from thermal drift, as well as other chronic shifts in relative positioning of the tips.

Referring again to FIG. 6, a block diagram illustrating an embodiment of a system and method for positioning the media platform and controlling tip offset is shown. Circuitry for executing the method communicated by the block diagram can exist partially or completely on one or both of the interface controller and the memory device. The diagram includes a coarse tracking loop for x-coarse positioning 380x and y-coarse positioning 380y. The coarse tracking loops 380x, 380y are employed to move the media so that the tips can scan the media in a down-track fashion. Servo information read by the tip is demodulated in the tip servo demodulator block 374 and provided to the supervisor 370 which then determines tip and media platform positioning. The supervisor 370 sends commands to the coarse tracking loops 380x, 380y and the tip positioning control 371 (which in an embodiment can comprise a planar offset register bank and/or a ramp generator). In an embodiment, the tip positioning control 371 receives commands periodically at a very slow rate for updating the tip offset and/or ramp slope. Where a ramp slope is common to the tips communicably connected with the media platform, a master DAC can be employed from the controller or the moving platform's coarse servo can be employed to include fine adjustment. The tip positioning control provides a fine position of the tip relative to some nominal tip position. The fine position as diagrammed can be summed 372 with the coarse position of the media platform (y-coarse, where tracks are arranged along an x scanning axis) to provide an absolute position. The difference between a known track position of a track n (wherein n is a target track) for which coarse movement is intended to position a tip, and the absolute position is a tracking error, Yₑᵣᵣₒᵣ. The tracking error of the tip can be provided to a demodulator that's reads servo information included on the tracks. Scanning across a track can produce, multiple tracking errors sufficient so that a complete scan can indicate whether the tip is properly aligned, with offsets, for example due to thermal drift, properly accounted. The tracking error information can be used to update a planar offset register bank and/or ramp generator. In an embodiment, four tips can be employed to determine tracking error during the scan, thereby requiring only four demodulators that can be multiplexed to some or all of the tips.

As mentioned, the coarse servo control loops 380 (which in an embodiment include one coarse servo employed for each of two perpendicular axes in a Cartesian plane) can be used to accomplish movement of the media platform with a desired degree of stability. The coarse servo control loops 380, when coupled with cap sensors allows a stabile servo loop to be closed, thereby making the media platform relatively stiff and fast. Each coarse servo loop 380 includes a feed-forward (F-F) trajectory generator 381 that estimates a trajectory of the platform for moving from a first position to a second position. Trajectory estimation drives current into coils of the electromagnetic motor to limit jerking of the media platform when moving at a desirably fast rate. To accomplish precise movement at a low bandwidth, trajectories (also referred to herein as motion profiles) can be fed forward and summed 384 with the primary servo control loop, as shown. The trajectory generator 381 can be trained so that, in an embodiment, approximately 90% of the signal providing an objective motion is learned, so that the servo control loop only has to provide correction and/or contribution approximating 10% of the signal providing an objective motion. To accomplish motion, a trajectory F-F is fed forward to a DAC 385 that sets a voltage for a plant 387 (i.e. an electromagnetic actuator). The signal is amplified by a power amplifier 386 and provided to the plant 387. Motion of the media platform can be measured by the capacitive sensors and the capacitance measurements are converted to a signal in rm ADC 388. The signal, represented as Xₚₒₛᵢₜᵢₒₙ, summed to a reference signal X_{ref} and provided to an equalizer 383 for generating a correction signal for the trajectory F-F. The media platform has a mass that is very small and a spring flexure (e.g. owing to bridging) that is high. Vibration reduction is desirable.

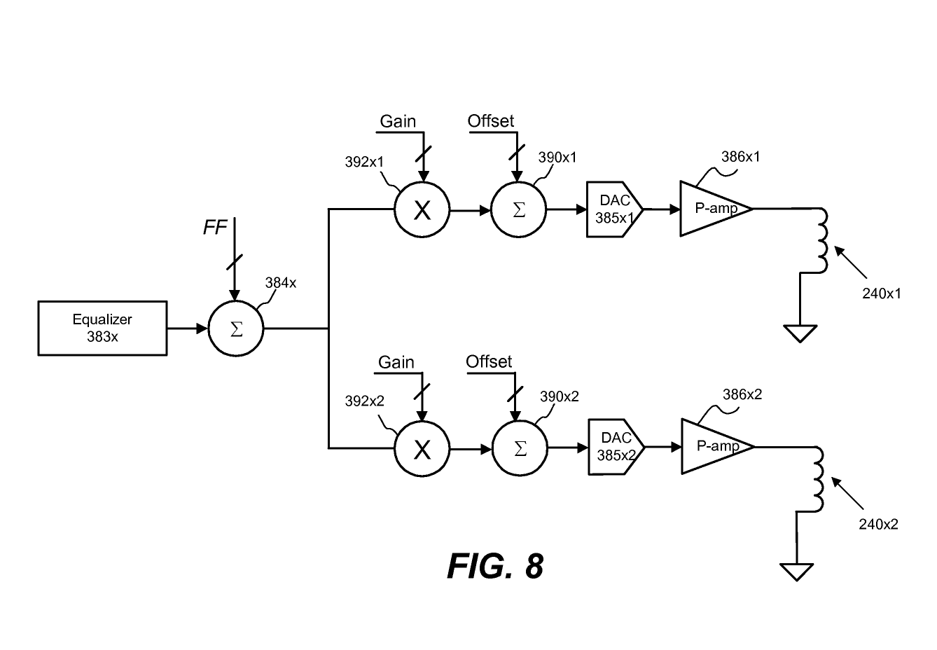

In embodiments having two coils for motion in the x axis and two coils for motion in the y axis it may be desired that force applied to the two coils be offset some small amount. Desirably, equal forces are generated by each coil of a pair of coils; however, offset force can be applied to impart a slight spill to correct for skew of the media platform. Ideally, skew is not necessary. However, where residual error exists, it may be advantageous to enable skew correction. Referring to FIG. 8 a block diagram illustrating a portion of an embodiment of a system and method for positioning the media platform and controlling tip offset is shown. A common signal, a sum 384x of the feed-forward signal F-F and a signal from the equalizer 383x, is sent to two DACs 385x1, 385x2 that provide a voltage to a corresponding power amplifier 386x1, 386x2, which in turn provides a voltage or current to the corresponding coil 340x1, 340x2. A gain 392x1 ,392x2 and/or DC offset 390x1, 390x2 affecting the common signal can be varied so that a signal provided to the power amplifier 386x1, 386x2 is corrected to account for some desired increase or decrease in one or both of the coils 340x1, 340x2 resulting in the media platform following a skewed trajectory. The skewed trajectory of the media platform thus offsets the skew of the media platform. Offset force can further be applied to correct other undesired media platform performance. For example, where there is a misbalance in the two coils due to a manufacturing or other defect (such as where there is a difference in the magnet forces) the defect can be compensated.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A system for storing information comprising:
a media;
a tip platform including a tip, the tip platform positioned relative to the media platform such that the tip is arrangeable in communicative proximity to the media; and
circuitry to provide motion signals to urge the media platform relative to the tip platform, the circuitry including a coarse tracking loop;
wherein the coarse tracking loop includes a trajectory generator and a primary control loop to adjust a trajectory generated by the trajectory generator based on a measurement of a position of the media relative to the tip.

2. The system of claim 1, further comprising:
a media die including a frame and a media platform movably coupled with the frame;
wherein the media is associated with the media platform;
one or more capacitive sensors including an electrode connected with the media platform;
wherein the primary control loop adjusts the trajectory generated by the trajectory generator based on a measurement from the one or more capacitive sensors.

3. The system of claim 1, further comprising:
a cantilever extending from the tip platform;
wherein:
the tip extends from the cantilever;
the cantilever is actuatable in a plane of the media; and
the circuitry further includes tip positioning control to actuate the cantilever.

4. The system of claim 3, wherein the tip positioning control includes one or both of a planar offset register bank and a ramp generator.

5. The system of claim 3, further comprising:
a plurality of cantilevers extending from the tip platform;
a plurality of tips extending from respective cantilevers;
wherein
the plurality of cantilevers are actuatable in a plane of the media; and
the circuitry further includes tip positioning control to actuate the cantilevers.

6. The system of claim 5, wherein the tip positioning control includes one or both of a planar offset register bank and a ramp generator.

7. The system of claim 2, further comprising:
an x-axis capacitive sensor including an electrode fixedly connected with the media platform and arranged to measure movement along an x-axis;
a y-axis capacitive sensor including an electrode fixedly connected with the media platform and arranged to measure movement along a y-axis;
wherein the circuitry to provide motion signals to urge the media platform relative to the tip platform includes an x-axis coarse tracking loop for providing an x-axis motion signal and a y-axis coarse tracking loop for providing a y-axis motion signal;
wherein the x-axis coarse tracking loop includes an x-axis trajectory generator and an x-axis primary control loop to refine a trajectory generated by the x-axis trajectory generator based on a measurement from the x-axis capacitive sensor; and
wherein the y-axis coarse tracking loop includes a y-axis trajectory generator and a y-axis primary control loop to adjust a trajectory generated by the y-axis trajectory generator based on a measurement from the y-axis capacitive sensor.

8. The system of claim 7, wherein:
the x-axis motion signal includes a signal for a first x-axis actuator and a signal for a second x-axis actuator;
the y-axis motion signal includes a signal for a first y-axis actuator and a signal for a second y-axis actuator;
the system further comprising:
a pair of x-axis capacitive sensors, each of the x-axis capacitive sensors including an electrode fixedly connected with the media platform and arranged to measure movement along an x-axis; and
a pair of y-axis capacitive sensors, each of the capacitive sensors including an electrode fixedly connected with the media platform and arranged to measure movement along a y-axis;
wherein the x-axis coarse tracking loop includes a gain and an off-set applied to one or both of the first x-axis actuator and the second x-axis actuator; and
wherein the y-axis coarse tracking loop includes a gain and an off-set applied to one or both of the first y-axis actuator and the second y-axis actuator.

9. The system of claim 8, wherein:
the first and second x-axis actuators are first and second x-axis voice coil motors; and
the first and second y-axis actuators are first a second y-axis voice coil motors.

10. The system of claim 1, wherein the trajectory generator is adapted to refine a trajectory based on the primary control loop.

11. A method of positioning a media relative to a tip in a probe storage system including circuitry with a coarse tracking loop to provide motion signals to urge the media relative to the tip, wherein the media includes an electrode of a capacitive sensor, the method comprising:
generating a trajectory for the media to be urged;
urging the media based on the trajectory;
receiving position information from the capacitive sensor; and
adjusting a position of the media using the position information.

12. The method of claim 11, further comprising refining the trajectory based on the position information.

13. The method of claim 11, wherein generating the trajectory further comprises:
determining an initial position using information read from the media by the tip;
identifying a final position based on an information request from a controller; and
generating the trajectory based on the initial position and the finial position.

14. The method of claim 13, wherein adjusting the position of the media further comprises:
measuring a change in capacitance of the capacitive sensor; and
providing a correction signal for the trajectory.

15. The method of claim 11, further comprising actuating the tip in a plane of the media.

16. The method of claim 13, further comprising actuating the tip in a plane of the media based on the initial position and the final position.

17. A system of storing information comprising:
a media movable relative to a tip;
a tip arrangeable in communicative proximity to the media
wherein the media is movable relative to the tip;
a capacitive sensor including an electrode fixed in position relative to the media and an electrode fixed in position relative to the tip;
circuitry to provide a signal to urge the media relative to the tip the circuitry including a coarse tracking loop;
wherein the coarse tracking loop includes a feed forward signal generated based on an initial position and a final position of the media relative to the tip and corrective signal based on a measurement of the capacitive sensor.

18. The system of claim 17, wherein the feed forward signal generated based on an initial position and a final position is adapted to be refined for use in the coarse tracking loop based on the primary control loop.

19. The probe storage system of claim 18, further comprising:
a cantilever from which the tip extends;
wherein the cantilever is actuatable in a plane of the media; and
wherein the circuitry further includes tip positioning control to actuate the cantilever.

20. The system of claim 19, wherein the tip positioning control includes one or both of a planar offset register bank and a ramp generator.

21. A system for storing information comprising:
a media;
a tip platform including a tip, the tip platform positioned relative to the media platform such that the tip is arrangeable in communicative proximity to the media; and
circuitry to provide motion signals to urge the media platform relative to the tip platform, the circuitry including a coarse tracking loop;
wherein the coarse tracking loop includes a trajectory generator and a primary control loop to adjust a generated by the trajectory generator based on a measurement of a position of the media relative to the tip.
